(19) United States
(12) Patent Application Publication
(10) Pub. No.: US 2015/0193396 A1
(43) Pub. Date: Jul. 9, 2015

(54) LOADING DEVICE SPECIFIC CONTENT AUTOMATICALLY WHEN SWITCHING BETWEEN DEVICES

(71) Applicant: Google Inc., (US)

(72) Inventors: Mark SCHNECKLOTH, Cupertino, CA (US); Garrett YAUN, Palo Alto, CA (US)

(73) Assignee: Google Inc., Mountain View, CA (US)

(21) Appl. No.: 13/864,183

(22) Filed: Apr. 16, 2013

(51) Int. Cl. G06F 17/22

(52) U.S. Cl. CPC G06F 17/2247

(57) ABSTRACT

The subject technology discloses configurations for providing automated synchronization of web pages from a desktop web client (e.g., a desktop web browser) to a web client on a mobile device, and/or vice-versa, that provides a preferred version of a synced web page according to a type of client that is viewing a web page. In one example, the subject technology tracks a status code for page transitions to keep a relationship for presenting the preferred version of a synced web page. For instance, such relationships may be stored at a server in a tab sync redirect table that includes one or more mappings of device types to URL pairs that are accessed by one or more computing devices.

The subject technology generally relates to the presentation of web pages on computing devices and synchronization of data between computing devices and/or servers.

### SUMMARY

The subject technology provides for a computer-implemented method, the method including: receiving a request for a first web page address from a web client; identifying a device type of the web client; determining if a redirect from the first web page address to a second web page address occurred based on the web client accessing the request for the first web page address in which the first web page address and the second web page address are alternate versions of a web page; and in response to determining that the redirect occurred, storing, in a table, a relationship indicating the first web page address, the second web page address and the identified device type of the web client.

The subject technology further provides for a computer-implemented method, the method including: receiving, by a web client, a request for a first web page address; identifying a device type of the web client; determining if an existing relationship is stored in a table based on the web page address from the request and the identified device type of the web client; retrieving a designated web page address from the existing relationship in response to determining that the existing relationship is stored in the table in which the designated web page address and the first web page address are alternate versions of a web page; and accessing, by the web client, the designated web page address.

Yet another aspect of the subject technology provides a system. The system includes one or more processors, and a memory including instructions stored therein, which when executed by the one or more processors, cause the processors to perform operations including: receiving a request for a first web page address from a web client; identifying a device type of the web client; determining if an existing relationship is stored in a table based on the first web page address from the request and the identified device type of the web client; retrieving a designated web page address from the existing relationship to forward to the second web client in response to determining that the existing relationship is stored in the table; determining if a redirect from the designated web page address to a second web page address occurred based on the web client accessing the request for the designated web page address in which the designated web page address and the second web page address are alternate versions of a web page; and in response to determining that the redirect occurred, storing, in a table, a relationship indicating the designated web page address, the second web page address and the identified device type of the web client in which the designated web page address comprises a source web page.

The subject technology further provides for a non-transitory machine-readable medium comprising instructions stored therein, which when executed by a machine, cause the machine to perform operations including: receiving, by a web client, a request for a first web page address; identifying a device type of the web client; determining if an existing relationship is stored in a table based on the web page address from the request and the identified device type of the web client; retrieving a designated web page address from the existing relationship in response to determining that the existing relationship is stored in the table in which the designated web page address and the first web page address are alternate versions of a web page; accessing, by the web client, the designated web page address; determining if a redirect from the designated web page address to a second web page occurred in which the designated web page address and the second web page are alternate versions of a web page; and transmitting a request for storing, in a table, a relationship indicating the designated web page address, the second web page and the identified device type of the web client.

It is understood that other configurations of the subject technology will become readily apparent from the following detailed description, where various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The features of the subject technology are set forth in the appended claims. However, for purpose of explanation, several configurations of the subject technology are set forth in the following figures.

FIG. 1 conceptually illustrates an example computing environment in which some configurations of the subject technology may be implemented.

FIG. 2 conceptually illustrates an exemplary server-side process for providing device specific content according to some configurations of the subject technology.

FIG. 3 conceptually illustrates an exemplary process for providing an inverted relationship according to some configurations of the subject technology.

FIG. 4 conceptually illustrates an exemplary client-side process for providing device specific content according to some configurations of the subject technology.

FIG. 5 conceptually illustrates a system with which some implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without these specific details. In some instances, structures and components are shown in block diagram form in order to avoid obscuring the concepts of the subject technology.

During a session with the mobile web client, a user may interact with the mobile web client by navigating to one or more different pages in which one or more tabbed windows can display the aforementioned pages. In some instances, the user may wish to have the state of the session including the tabbed window activity synchronized to another device, such as a desktop web client (e.g., a desktop web browser) on a desktop computing device (e.g., desktop computer, laptop, notebook, etc.). However, when syncing tabs with respective web pages between devices, a preferred web page for a device could be a different type of web page suited for that particular device. For instance, when using a mobile device such as a smartphone, a user may wish to navigate to a web page that immediately redirects to a mobile version of that web page (e.g., “www.foobar123.com” redirects a mobile device to “m.foobar123.com”). When syncing tabs over to the desktop computing device, in contrast, the user could wish to start at a non-mobile version of the web page instead of having a mobile version of the web page be synced to the desktop computing device.

If the web page is synced to the desktop web client, the user may wish that the desktop version of the web page be presented to the user. In one example, when tab syncing is enabled, the uniform resource locators (URLs) of web pages that a user has visited are sent back to a server. At the server, these URLs are stored and can be sent to the user's other devices (if the user desires) in order to synchronize visited web pages. However, in some instances in which a device is redirected to a different version of a web page, the URL from one device may not be the preferred URL for another device. For instance, once redirected to the mobile version of the web page at the mobile device, the desktop computing device would have the mobile version of the web page synced back to it instead of the desired non-mobile version.

The subject technology provides automated synchronization of web pages from a desktop web client (e.g., a desktop web browser) to a web client on a mobile device, and/or vice-versa, that provides a preferred version of a synced web page according to a type of client that is viewing a web page. In one example, the subject technology tracks a status code for page transitions to keep a relationship for presenting the preferred version of a synced web page. As used herein, the term “relationship” includes its plain and ordinary meaning including, but not limited to, a mapping of a device type(s) to one or more pairings of respective web site addresses. For instance, such relationships could be stored at a server in a tab sync redirect table that includes one or more mappings of device types to URL pairs, such as the following:

www.websiteFGH.com, m.websiteFGH.com, mobile browser

In one example, a mobile web browser visits a web page and is redirected to the mobile version of the web page (e.g., “www.websiteFOOBAR.com” redirects “m. websiteFOOBAR.com”). The status code upon initially retrieving the web page could indicate a redirect (e.g., HTTP status code 301 or 302) to a different version of the web page (e.g., a mobile version). This status code and relationship pairing could then be utilized to forgo a redirect in a future instance(s) in which the mobile device (or another mobile device) visits the same web page. The subject technology therefore enables a web client to directly load the desired version of the web page with device-specific content instead of undergoing an initial visit to a main web page and then being redirected to another version of the web page (e.g., mobile). This provides the advantages of saving network bandwidth along with reducing processing time on both the server and client side.

In one example, when syncing web pages, the subject technology enables the non-mobile version of the web browser to load the version of the web page that is consistent with the version of the web page that the user expects to view on a particular web browser (non-mobile versus mobile web browser). This improves the user experience by having synced web pages present a more suitable web page based on the device that is viewing the synced web pages. More specifically, when loading the mobile version of the web page to a device that is not running a mobile web browser, the user may prefer the source of the redirect (e.g., the non-mobile version of the web page) instead of the redirect target of the mobile web page.

Some example entries in the tab sync redirect table for relationships could be represented as the following:

www. website123.com/title/tt1014759/, m.website123.com/title/tt1014759/mobile browser

m.website123.com/title/tt1014759/, www.website123.com/title/tt1014759/!mobile browser

www.websiteJKL.com/biz/target-foobar, m.websiteJKL.com/biz/target-foobar, mobile browser

In some configurations, the subject technology can detect that a redirect occurred based on a status code upon initially retrieving the web page, and choose to sync the source of the redirect (e.g., non-mobile version of the web page) to the server. A desktop device can then have the source of the redirect be synced. In an example in which another mobile device is syncing the source of the redirect, this other mobile device would undergo a redirect to get to the mobile version of the web page. This example forgoes the overhead of having a history of relationships and status codes described above, but at a potential expense of having another redirect occur for other devices.

In some configurations, the subject technology could be integrated with a search engine to improve the user experience when viewing a corresponding web page from a search result. For instance, search results returned from a query on a mobile device may have the user navigate directly to the mobile version of the page based on the table created from the above-discussed tab sync redirect table in order to send the user to the mobile content without undergoing a HTTP redirect.

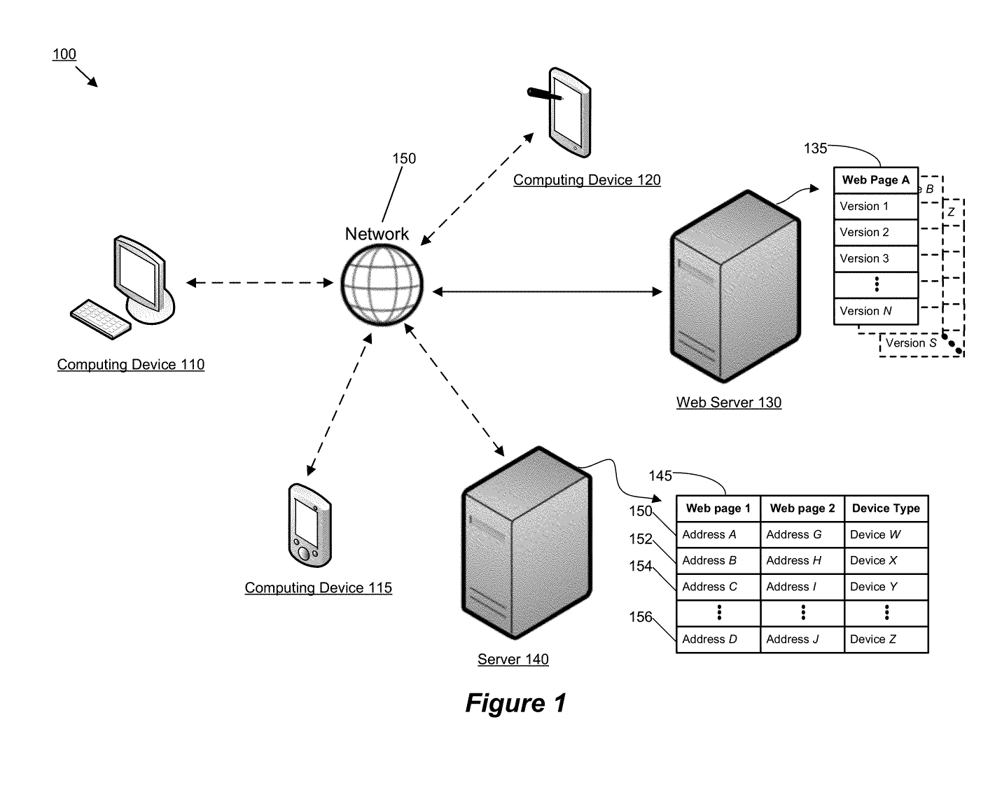

FIG. 1 conceptually illustrates an example computing environment 100 in which some configurations of the subject technology may be implemented. As shown in the example of FIG. 1, computing devices 110, 115 and 120 may communicate over a network 150 in order to transmit data, including synchronization of web activity data for web browsing sessions on respective web clients that may be running on all or a subset of the computing devices 110, 115 and 120. Each of the computing devices 110, 115 and 120 represent different client computing devices that may access a web server 130 and server 140. For instance, the computing device 110 may represent a desktop client computing device, the computing device 115 may represent a mobile computing device (e.g., smartphone, phablet, etc.), and the computing device 120 may represent a tablet device. Other types of computing devices may be provided and still be within the scope of the subject technology. For example, a watch-sized computing device, eyeglass computing device, wearable computing device, or television may be provided in the computing environment 100.

As further illustrated in FIG. 1, the web server may provide or host a set of web pages 135. One or more alternate versions of a web page may be included in the set of web pages 135. One version from among the alternate versions of the web page may include a mobile version, desktop version, tablet version, watch size interface version, or eyeglass size interface version, etc. Other versions of the web page may be provided and still be within the scope of the subject technology. Each version of a given web page may include device specific content for presenting to a device type of a client computing device. For instance, a mobile version of a web page may include content formatted for display on a web browser running on a mobile device.

In some configurations, the server 140 provides a tab sync redirect table 145 that stores a set of relationships 150, 152, 154 and 156. The example tab sync redirect table 145 includes respective columns for a first web page address (“Web page 1”), a second web page address (“Web page 2”), and a device type (“Device Type”). Each row in the tab sync redirect table represents a relationship defined by the web page address pairs and the device type. The tab sync redirect table is stored at a different network location at the server 140 than the respective network locations of the computing devices 110, 115 and 120 in one example. Although the example of FIG. 1 illustrates that the tab sync redirect table 145 is provided by the server 140, it should be appreciated that some configurations of the subject technology may have one or more client computing devices (e.g., computing devices 110, 115 and 120) that provide a locally stored tab sync redirect table. Thus, server-side and client-side implementations of a tab sync redirect table are described herein.

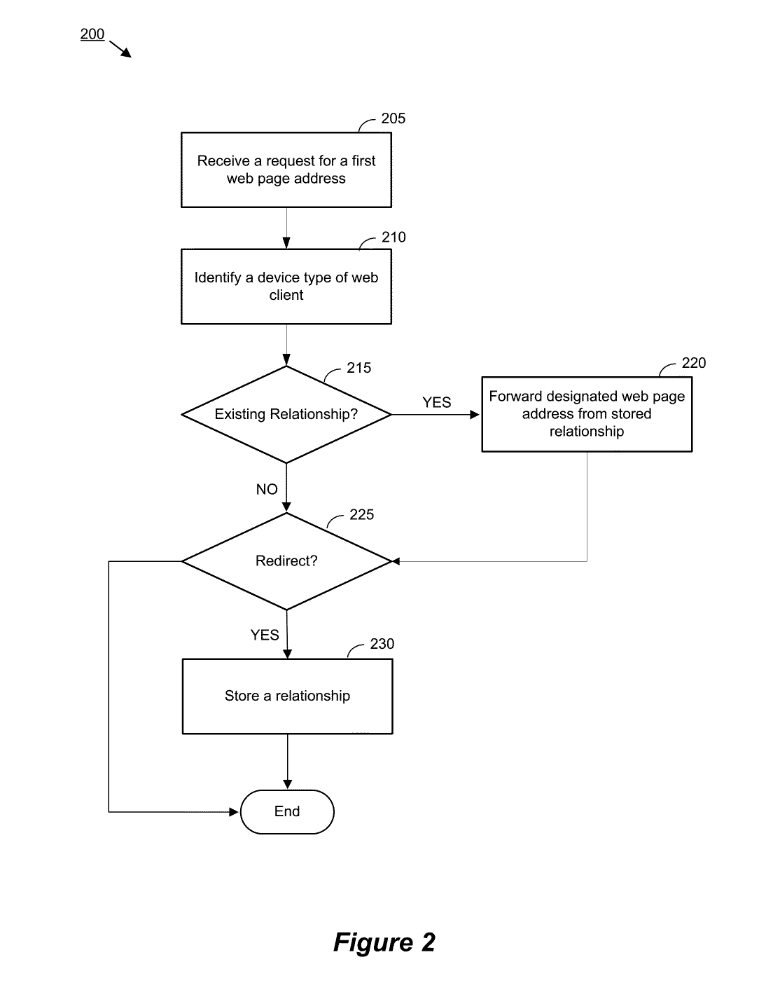

FIG. 2 conceptually illustrates an exemplary server-side process 200 for providing device specific content according to some configurations of the subject technology. The process 200 can be performed on one or more computing devices or systems in some configurations. More specifically, in configurations that a server computing system/device provides a tab sync redirect table that is accessed by one or more web clients (e.g., different web browsers running on different computing devices), the process 200 may be implemented by such a server computing system/device as described below.

The process 200 begins at 205 by receiving a request for a first web page address from a web client. The first web page address may be considered a “source” web page that the web client is requesting to access. The web page address may be represented in a format of a uniform resource locator (URL) to reference a web address (e.g., HTTP address of a web site and may include a name of a web page hosted by the web site). The web client may transmit, over a network, the request that is received by a server/system implementing the process 200 in one example.

The process 200 at 210 identifies a device type of the web client based on the request from the web client. In one example, the device type may be identified based on a “User-Agent” string included in a HTTP request or HTTP header in the request. By way of example, the format of the User-Agent string in HTTP may be a list of product tokens (keywords) with optional comments. For instance, one example User-Agent string may be syntactically denoted as the following:

Mozilla/[version] ([system and browser information]) [platform] ([platform details]) [extensions]

At 215, the process 200 determines if an existing relationship is stored in a table (e.g., table 140 corresponding to a tab sync redirect table) based on the web page address from the request and the identified device type of the second web client. In the table, the existing relationship may be represented as a requested web page address (e.g., the aforementioned first web page address), a designated web page address indicating a location of device specific content, and a device type that corresponds to the device specific content at the designated web page address. In some configurations, the existing relationship further comprises a unary operation that indicates a logical negation of the device type (e.g., ![device type]).

The process 200 at 220 retrieves a designated web page address from the existing relationship to forward to the web client in response to determining that the existing relationship is stored in the table. In this regard, retrieving the designated web page address from the stored relationship may include selecting a respective web page address based on the identified device type. For instance, the identified device type indicates a version of a web page (e.g., desktop, mobile, tablet, watch interface, etc.) that includes device content suitable for display by the identified device type. The process 200 then continues to 225 described below.

At 225, the process 200 determines if a redirect from the first web page address to a second web page address occurred based on the web client accessing the request for the first web page address. A redirect may occur when a web server hosting the first page detects that another version of the web page should be provided to the web client. In one example, the first web page address and the second web page address are alternate versions of a web page. One version from among the alternate versions of the web page may include a mobile version, desktop version, tablet version, watch size interface version, or eyeglass size interface version. Other alternate versions of the web page may be included and still be within the scope of the subject technology.

In one example, determining if the redirect from the first web page address to the second web page address occurred at 215 is based on a Hypertext Transfer Protocol (HTTP) status code. For example, the HTTP status code indicates a uniform resource locator (URL) redirection from the first web page address to the second web page address. If a redirect does not occur at 225, the process 200 then ends.

In response to determining that the redirect occurred at 225, the process 200 at 230 stores, in a table, a relationship indicating a first web page address, a second web page address and an identified device type of the web client. In some configurations, the first web page address may be a web page address included in the request from the web client, and the second web page address may be a designated web page address that includes device specific content for the web client. The process 200 then ends.

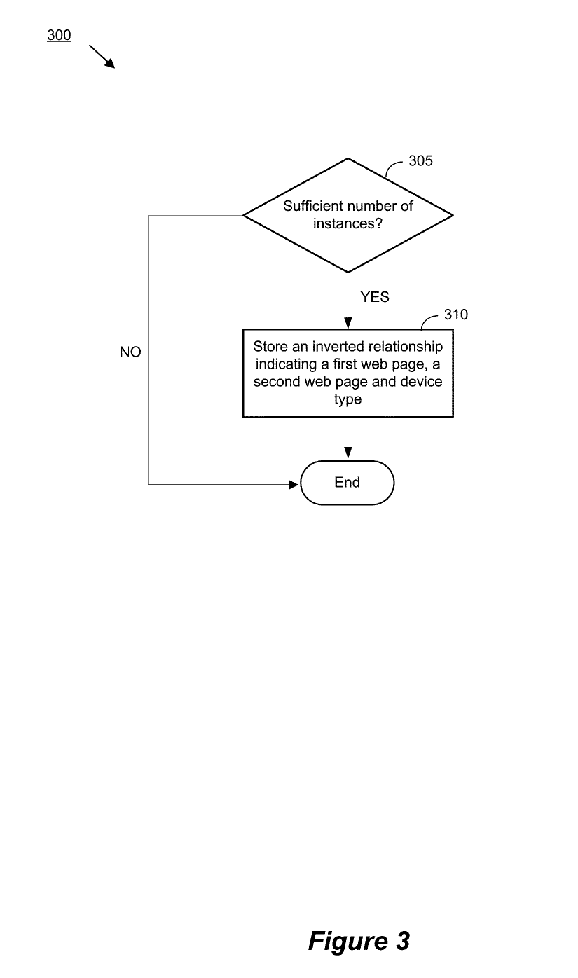

FIG. 3 conceptually illustrates an exemplary process 300 for providing an inverted relationship according to some configurations of the subject technology. The process 300 can be performed on one or more computing devices or systems in some configurations. More specifically, in configurations that a server computing system/device provides a tab sync redirect table that is accessed by one or more web clients (e.g., different web browsers running on different computing devices), the process 300 may be implemented by such a server computing system/device as described below. Alternatively, the process 300 may be implemented by a client computing device if the tab sync redirect table is stored locally on the client computing device.

In some configurations, if a sufficient number of instances of a relationship are stored in a tab sync redirect table (e.g., to meet a predetermined threshold number of instances), the relationship may be inverted to store a URL that is automatically retrieved by a particular web client. In one example, an existing relationship may be represented by the following:

www. websiteXYZ.com, m.websiteXYZ.com, mobile browser

Thus, an inverted relationship of the above example relationship may be represented as the following example:

m.websiteXYZ.com, www.websiteXYZ.com, !mobile browser

The above URL pairs and device type string indicate that that a non-mobile version of the web page should be loaded by a non-mobile web browser. As shown in the above example, a unary operation is applied to a device type (e.g., “mobile browser”) to indicate a logical negation. The above example inverted relationship indicates that in the event that a non-mobile web browser requests or syncs the web page address “m.websiteXYZ.com” (e.g., the root web address of a mobile version of a web site), the web page address “websiteXYZ.com” (e.g., the root web address of a non-mobile version of the web site) is provided to the non-mobile web browser so that appropriate device content is presented to the non-mobile web browser. The process 300 described below includes one example for providing an inverted relationship for including in a tab sync redirect table described herein.

The process 300 begins at 305 by determining if a sufficient number of instances of a relationship are stored in a table to meet a predetermined threshold number of instances. If so, the process 300 continues to 310 to store an inverted relationship based on the relationship indicating a first web page, a second web page and a device type. The process 300 then ends.

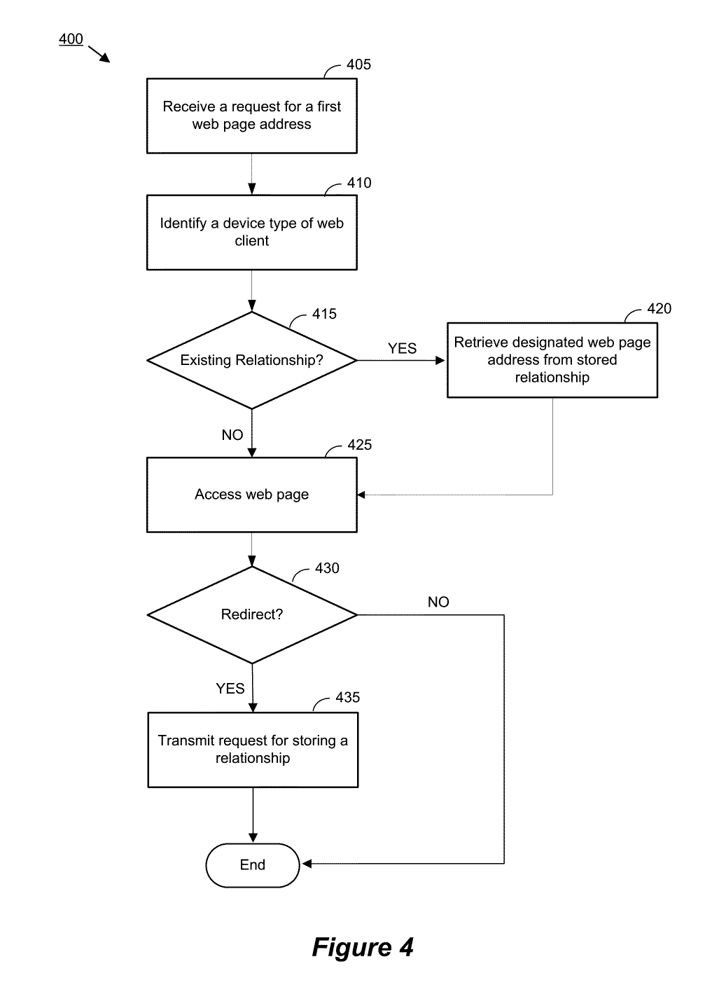

FIG. 4 conceptually illustrates an exemplary client-side process 400 for providing device specific content according to some configurations of the subject technology. The process 400 can be performed on one or more computing devices or systems in some configurations. More specifically, in configurations that a client computing device accesses a tab sync redirect table provided on the client computing device or a server, the process 400 may be implemented by such a client computing device as described below.

The process 400 begins at 405 by receiving, by a web client, a request for a first web page address. In one example, the request for the first web page address is part of a synchronization of web activity data between the web client and a second web client, and the web client and second web client are provided by different computing devices (e.g., mobile device, desktop device, tablet, wristwatch, television, etc.)

The process 400 at 410 identifies a device type of the web client. At 415, the process 400 determines if an existing relationship is stored in a table (e.g., a tab sync redirect table including one or more relationships describing URL pairs to device types) based on the web page address from the request and the identified device type of the web client.

At 420, the process 400 retrieves a designated web page address from the existing relationship in response to determining that the existing relationship is stored in the table. In one example, the designated web page address and the first web page address are alternate versions of a web page.

The process 400 at 425 accesses, by the web client, the designated web page address. At 430, the process 400 determines if a redirect from the designated web page address to a second web page address occurred in which the designated web page address and the second web page address are alternate versions of a web page. If there is no redirect, the process 400 ends.

If a redirect was determined to occur at 430, the process 400 continues to 435 to transmit a request for storing, in a table, a relationship indicating the designated web page address, the second web page address and the identified device type of the web client. If the table is stored remotely in a server, the request is transmitted over a network; alternatively, if the table is locally stored at the client computing device running the web client, the request is transmitted locally to store the relationship in the locally stored table. In this example, the designated web page address is considered a source web page that the web client is requesting to access (e.g., at 425). The process 400 then ends.

Many of the above-described features and applications are implemented as software processes that are specified as a set of instructions recorded on a non-transitory machine readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of non-transitory machine readable media include, but are not limited to, CD-ROMs, flash drives, RAM chips, hard drives, EPROMs, etc. The machine readable media does not include carrier waves and electronic signals passing wirelessly or over wired connections.

In this specification, the term “software” is meant to include firmware residing in read-only memory and/or applications stored in magnetic storage, which can be read into memory for processing by a processor. Also, in some implementations, multiple software components can be implemented as sub-parts of a larger program while remaining distinct software components. In some implementations, multiple software subject components can also be implemented as separate programs. Finally, a combination of separate programs that together implement a software component(s) described here is within the scope of the subject technology. In some implementations, the software programs, when installed to operate on one or more systems, define one or more specific machine implementations that execute and perform the operations of the software programs.

A computer program (also known as a program, software, software application, script, or code) can be written in a form of programming language, including compiled or interpreted languages, declarative or procedural languages, and it can be deployed in some form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some configurations are implemented as software processes that include one or more application programming interfaces (APIs) in an environment with calling program code interacting with other program code being called through the one or more interfaces. Various function calls, messages or other types of invocations, which can include various kinds of parameters, can be transferred via the APIs between the calling program and the code being called. In addition, an API can provide the calling program code the ability to use data types or classes defined in the API and implemented in the called program code.

One or more APIs may be used in some configurations. An API is an interface implemented by a program code component or hardware component (“API implementing component”) that allows a different program code component or hardware component (“API calling component”) to access and use one or more functions, methods, procedures, data structures, classes, and/or other services provided by the API implementing component. An API can define one or more parameters that are passed between the API calling component and the API implementing component.

The following description describes an example system in which aspects of the subject technology can be implemented.

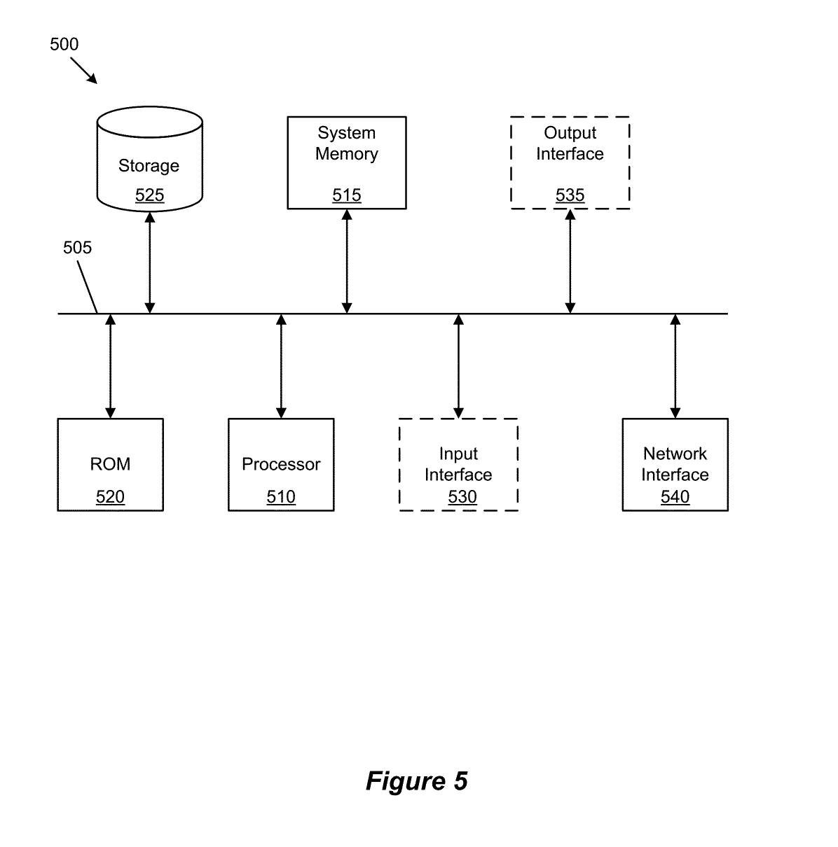

FIG. 5 conceptually illustrates a system 500 with which some implementations of the subject technology can be implemented. The system 500 can be a computer, phone, PDA, or another sort of electronic device. In some configurations, the system 500 includes a television with one or more processors embedded therein. Such a system includes various types of computer readable media and interfaces for various other types of computer readable media. The system 500 includes a bus 505, processing unit(s) 510, a system memory 515, a read-only memory 520, a storage device 525, an optional input interface 530, an optional output interface 535, and a network interface 540.

The bus 505 collectively represents all system, peripheral, and chipset buses that communicatively connect the numerous internal devices of the system 500. For instance, the bus 505 communicatively connects the processing unit(s) 510 with the read-only memory 520, the system memory 515, and the storage device 525.

From these various memory units, the processing unit(s) 510 retrieves instructions to execute and data to process in order to execute the processes of the subject technology. The processing unit(s) can be a single processor or a multi-core processor in different implementations.

The read-only-memory (ROM) 520 stores static data and instructions that are needed by the processing unit(s) 510 and other modules of the system 500. The storage device 525, on the other hand, is a read-and-write memory device. This device is a non-volatile memory unit that stores instructions and data even when the system 500 is off. Some implementations of the subject technology use a mass-storage device (such as a magnetic or optical disk and its corresponding disk drive) as the storage device 525.

Other implementations use a removable storage device (such as a flash drive, a floppy disk, and its corresponding disk drive) as the storage device 525. Like the storage device 525, the system memory 515 is a read-and-write memory device. However, unlike storage device 525, the system memory 515 is a volatile read-and-write memory, such a random access memory. The system memory 515 stores some of the instructions and data that the processor needs at runtime. In some implementations, the subject technology's processes are stored in the system memory 515, the storage device 525, and/or the read-only memory 520. For example, the various memory units include instructions for processing multimedia items in accordance with some implementations. From these various memory units, the processing unit(s) 510 retrieves instructions to execute and data to process in order to execute the processes of some implementations.

The bus 505 also connects to the optional input and output interfaces 530 and 535. The optional input interface 530 enables the user to communicate information and select commands to the system. The optional input interface 530 can interface with alphanumeric keyboards and pointing devices (also called “cursor control devices”). The optional output interface 535 can provide display images generated by the system 500. The optional output interface 535 can interface with printers and display devices, such as cathode ray tubes (CRT) or liquid crystal displays (LCD). Some implementations can interface with devices such as a touchscreen that functions as both input and output devices.

Finally, as shown in FIG. 5, bus 505 also couples system 500 to a network interface 540 through a network adapter (not shown). In this manner, the computer can be a part of a network of computers (such as a local area network (“LAN”), a wide area network (“WAN”), or an Intranet, or an interconnected network of networks, such as the Internet. The components of system 500 can be used in conjunction with the subject technology.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a non-transitory machine-readable or non-transitory computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself

As used in this specification and the claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and the claims of this application, the terms “computer readable medium” and “computer readable media” are entirely restricted to tangible, physical objects that store information in a form that is readable by a computer. These terms exclude wireless signals, wired download signals, and other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be a form of sensory feedback, e.g., visual feedback, auditory feedback, or tactile feedback; and input from the user can be received in a form, including acoustic, speech, or tactile input. In addition, a computer can interact with a user by sending documents to and receiving documents from a device that is used by the user; for example, by sending web pages to a web browser on a user's client device in response to requests received from the web browser.

Configurations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or a combination of one or more such back end, middleware, or front end components. The components of the system can be interconnected by a form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some configurations, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that a specific order or hierarchy of steps in the processes disclosed is an illustration of example approaches. Based upon design preferences, it is understood that the specific order or hierarchy of steps in the processes can be rearranged, or that all illustrated steps be performed. Some of the steps can be performed simultaneously. For example, in certain circumstances, multitasking and parallel processing can be advantageous. Moreover, the separation of various system components in the configurations described above should not be understood as requiring such separation in all configurations, and it should be understood that the described program components and systems can generally be integrated together in a single software product or packaged into multiple software products.

The previous description is provided to enable a person skilled in the art to practice the various aspects described herein. Various modifications to these aspects will be readily apparent to those skilled in the art, and the generic principles defined herein can be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase such as an “aspect” does not imply that such aspect is essential to the subject technology or that such aspect applies to all configurations of the subject technology. A disclosure relating to an aspect can apply to all configurations, or one or more configurations. A phrase such as an aspect can refer to one or more aspects and vice versa. A phrase such as a “configuration” does not imply that such configuration is essential to the subject technology or that such configuration applies to all configurations of the subject technology. A disclosure relating to a configuration can apply to all configurations, or one or more configurations. A phrase such as a configuration can refer to one or more configurations and vice versa.

The word “example” is used herein to mean “serving as an example or illustration.” An aspect or design described herein as “example” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims.

What is claimed is:

1. A computer-implemented method, the method comprising:
receiving a request for a first web page address from a web client;
identifying a device type of the web client;
determining if a redirect from the first web page address to a second web page address occurred based on the web client accessing the request for the first web page address, wherein the first web page address and the second web page address are alternate versions of a web page; and
in response to determining that the redirect occurred, storing, in a table, a relationship indicating the first web page address, the second web page address and the identified device type of the web client.

2. The method of claim 1, wherein the first web page address comprises a source web page.

3. The method of claim 2, wherein one version from among the alternate versions of the web page comprises a mobile version, desktop version, tablet version, watch size interface version, or eyeglass size interface version.

4. The method of claim 1, wherein determining if the redirect from the first web page address to the second web page address occurred is based on a Hypertext Transfer Protocol (HTTP) status code.

5. The method of claim 4, wherein the HTTP status code indicates a uniform resource locator (URL) redirection.

6. The method of claim 1, further comprising:
identifying a device type of a second web client based on a request from the second web client, wherein the request includes a web page address;
determining if an existing relationship is stored in the table based on the web page address from the request and the identified device type of the second web client; and
retrieving a designated web page address from the existing relationship to forward to the second web client in response to determining that the existing relationship is stored in the table.

7. The method of claim 6, wherein the existing relationship comprises a requested web page address, the designated web page address, and a device type.

8. The method of claim 7, wherein the existing relationship further comprises a unary operation that indicates a logical negation of the device type.

9. The method of claim 6, wherein retrieving the designated web page address from the stored relationship comprises:
selecting a respective web page address based on the identified device type, wherein the identified device type indicates a version of a web page suitable for display by the identified device type.

10. The method of claim 8, wherein the identified device type of the web client and the identified device type of the second web client are different device types.

11. The method of claim 1, wherein receiving the request for the first web page address occurs at a different network location from a network location of the web client.

12. The method of claim 11, wherein the table is stored at the different network location from the network location of the web client.

13. The method of claim 1, wherein the first web page address is provided in a set of web page addresses included in a search result.

14. A computer-implemented method, the method comprising:
receiving, by a web client, a request for a first web page address;
identifying a device type of the web client;
determining if an existing relationship is stored in a table based on the web page address from the request and the identified device type of the web client;
retrieving a designated web page address from the existing relationship in response to determining that the existing relationship is stored in the table, wherein the designated web page address and the first web page address are alternate versions of a web page; and
accessing, by the web client, the designated web page address.

15. The method of claim 14, further comprising:
determining if a redirect from the designated web page address to a second web page address occurred, wherein the designated web page address and the second web page address are alternate versions of a web page; and
transmitting a request for storing, in a table, a relationship indicating the designated web page address, the second web page address and the identified device type of the web client, wherein the designated web page address comprises a source web page.

16. The method of claim 14, wherein the request for the first web page address is part of a synchronization of web activity data between the web client and a second web client, and the web client and second web client are provided by different computing devices.

17. The method of claim 14, wherein one version from among the alternate versions of the web page comprises a mobile version, desktop version, tablet version, watch size interface version, or eyeglass size interface version.

18. The method of claim 15, wherein determining if the redirect from the designated web page address to the second web page address occurred is based on a Hypertext Transfer Protocol (HTTP) status code.

19. A system, the system comprising:
one or more processors;
a memory comprising instructions stored therein, which when executed by the one or more processors, cause the processors to perform operations comprising:
receiving a request for a first web page address from a web client;
identifying a device type of the web client;
determining if an existing relationship is stored in a table based on the first web page address from the request and the identified device type of the web client;
retrieving a designated web page address from the existing relationship to forward to the second web client in response to determining that the existing relationship is stored in the table;
determining if a redirect from the designated web page address to a second web page address occurred based on the web client accessing the request for the designated web page address, wherein the designated web page address and the second web page address are alternate versions of a web page; and
in response to determining that the redirect occurred, storing, in a table, a relationship indicating the designated web page address, the second web page address and the identified device type of the web client, wherein the designated web page address comprises a source web page.

20. A non-transitory machine-readable medium comprising instructions stored therein, which when executed by a machine, cause the machine to perform operations comprising:
receiving, by a web client, a request for a first web page address;
identifying a device type of the web client;
determining if an existing relationship is stored in a table based on the web page address from the request and the identified device type of the web client;
retrieving a designated web page address from the existing relationship in response to determining that the existing relationship is stored in the table, wherein the designated web page address and the first web page address are alternate versions of a web page;
accessing, by the web client, the designated web page address;
determining if a redirect from the designated web page address to a second web page occurred, wherein the designated web page address and the second web page are alternate versions of a web page; and
transmitting a request for storing, in a table, a relationship indicating the designated web page address, the second web page and the identified device type of the web client.
